(19) United States
(12) Patent Application Publication
(10) Pub. No.: US 2022/0373014 A1
(43) Pub. Date: Nov. 24, 2022

(54) BOLT WITH ADJUSTABLE CLAMPING RANGE

(71) Applicant: Bernd Siegmund GmbH, 86507 Oberottmarshausen (DE)

(72) Inventors: Bernd Siegmund, Grossaitingen (DE); THOMAS ZINK, Bobingen (DE)

(73) Assignee: Bernd Siegmund GmbH, 86507 Oberottmarshausen (DE)

(21) Appl. No.: 17/767,338

(22) PCT Filed: Nov. 2, 2019
(86) PCT No.: PCT/EP2019/025377

§ 371 Date: Apr. 7, 2022

(51) Int. Cl. F16B 21/16; F16B 19/00

(52) U.S. Cl. CPC F16B 21/165; F16B 19/002; F16B 2019/006

(57) ABSTRACT

A bolt for clamping abutting parts includes a bolt-like part insertable into openings of the abutting parts and including an external thread on a portion of an outer side of the bolt-like part. The bolt-like part includes a bolt component without external thread so that the bolt extends in each of the abutting parts at least partially with the bolt component without external thread. A threaded sleeve projects radially outwardly beyond the bolt-like part and is positionally adjustable by engaging an internal thread of the threaded sleeve in the external thread of the bolt-like part. A clamping element is provided inside the bolt-like part at an end of the bolt-like part in opposition to the threaded sleeve and is movable beyond an outer circumference of the bolt-like part through a bore of the bolt-like part. An actuator acts on the clamping element in order to clamp the abutting parts.

The invention relates to a bolt with adjustable clamping range for clamping abutting parts having openings, comprising a bolt-like part insertable into the openings from one side of the abutting parts, a threaded sleeve radially projecting outwardly beyond the bolt-like part and positionally adjustable and fixable in longitudinal direction of the bolt-like part by engaging the threaded sleeve with an internal thread in an external thread provided on a portion of the outer side of the bolt-like part, at least one clamping element which is provided inside the bolt-like part at the end of the bolt-like part opposite the threaded sleeve and which is movable through at least one opening across the outer circumference of the bolt-like part, and an actuator which acts on the at least one clamping element to clamp the abutting parts.

DE 199 17 209 C2 discloses a bolt of the afore-mentioned type, with which two or more abutting parts of any type can be clamped together. Such bolts include a bolt-like part having one end at which an actuator is provided. For example, a threaded spindle can be screwed in from the one end face, which threaded spindle projects beyond the bolt-like part at this end and at the same time serves as a hand wheel, usually with enlarged diameter in relation to the bolt-like part. In addition, quick-action clamping mechanisms are known, Provision is made at this end of the bolt-like part for a threaded sleeve, which projects radially outwardly beyond the bolt-like part and is positionally adjustable and fixable in longitudinal direction of the bolt-like part by engaging the threaded sleeve with an internal thread in an external thread provided on a portion of the outer side of the bolt-like part. Arranged at the opposite end are radially outwardly extending openings in the bolt-like part, through which openings clamping elements, for example balls or sliding elements, are movable outwardly to such an extent that they project beyond the outer circumference of the bolt-like part in this area. The radial outward movement of balls as clamping elements is achieved with the aid of the threaded spindle, which engages the balls in the area of the clamping elements via a central ball. When the threaded spindle is screwed forward, the central ball pushes the balls as clamping elements outwards so that they protrude beyond the outer circumference of the bolt-like part. Prior to clamping, the clamping elements are in the retracted state inside the bolt-like part. This makes it possible to push the bolt with the end having the clamping elements through the aligned openings of the abutting parts until the threaded sleeve is supported on the one surface of a part and the clamping elements are situated anteriorly of the outer surface of the parts. The threaded spindle is now screwed forward with the aid of the handle, causing the clamping elements to be pushed outwards and the abutting parts to be clamped between clamping elements and threaded sleeve. This makes it possible to connect two or more parts easily, with very high load-bearing capacity and without play, in just a few steps, By adjusting the threaded sleeve on the external thread, abutting parts of different strength can be clamped together.

For example, such bolts find application in combination with welding and clamping table systems with which objects can be clamped and welded or otherwise manipulated. Parts to be clamped can be the table top or side panels of a welding and clamping table and planar or angular additional parts which can be fastened to the table with the aid of such bolts, thereby establishing straight and right-angled clamping means with stop surfaces for the welded part to be produced at any area. In addition, such bolts may find application wherever two or more abutting parts are to be clamped together. The openings in the abutting parts can be bores or oblong holes.

The discussed prior art, however, is disadvantageous in that transverse forces acting on one of the abutting parts can damage the external thread. In particular, when oblong holes are involved as openings, a secure clamping cannot be ensured.

The invention is based on the problem to advantageously further develop the prior art.

This object is attained with the features of the independent claim. Advantageous configurations of the invention are set forth in the dependent claims.

According to the invention, it is proposed that the bolt inserted into the openings of the abutting parts extends in each of the abutting parts at least partially with a bolt component without an external thread. This ensures that the bolt is guided in each of the abutting parts with its full outer circumference which matches the openings, thereby improving the positional accuracy. Any transverse forces that may be encountered are absorbed by the full diameter of the bolt and do not affect the external thread. In addition, secure clamping is made possible, especially in oblong holes. At the same time, the clamping range of the bolt is adjustable, so as to enable use of the bolt in particular for fastening laser templates on breadboard tables.

According to a first embodiment of the invention, provision is made for the external thread to extend only partially into one of the abutting parts, when the bolt is inserted into the openings of the abutting parts. As a result, the part of the bolt-like part without external thread extends completely in one of the abutting parts and at least partially in the other one of the abutting parts. Transverse forces on one of the abutting parts thus act on the full diameter of the bolt-like part at all times and not on the external thread.

In order to achieve a greatest possible way of adjusting the clamping range, it is proposed to provide the internal thread only in a portion of the threaded sleeve and to have the remaining internal region of the threaded sleeve to overlap the external thread.

According to a second embodiment of the invention, provision is made for the threaded sleeve to have a projection which has an outer circumference corresponding to the outer circumference of the bolt-like part and is insertable into one of the openings of the abutting parts. Thus, during clamping, a part of the threaded sleeve extends into the opening of one of the abutting parts and the area of the bolt-like part without external thread extends into the opening of the other one of the abutting parts. Here, too, transverse forces upon one of the abutting parts act on the full diameter of the bolt-like part at ail times and not on the external thread, as this is realized on one hand directly and on the other hand via the projection of the threaded sleeve.

To prevent an inadvertent adjustment of the threaded sleeve on the external thread, it is proposed to provide the threaded sleeve with an internal O-ring which inhibits adjustability of the threaded sleeve on the external thread.

In order to facilitate adjustment of the clamping range, it is proposed to provide the external thread with a milled recess in which a scale for adjustment of the thickness of the abutting parts is attached.

Exemplary embodiments of the invention are explained in greater detail with reference to the drawing. It is shown in:

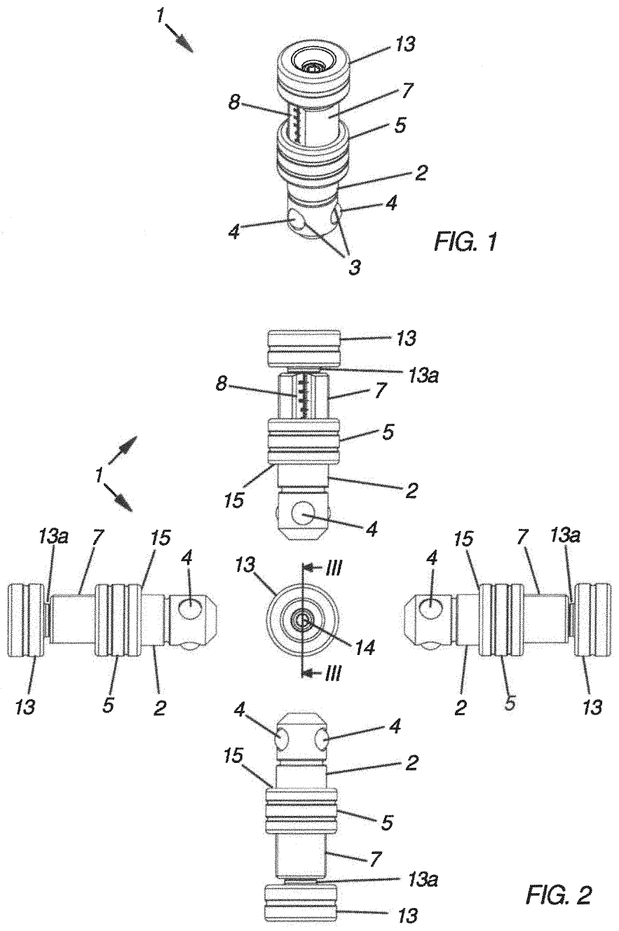

FIG. 1 a perspective view of a first embodiment of the bolt,

FIG. 2 different views of the bolt,

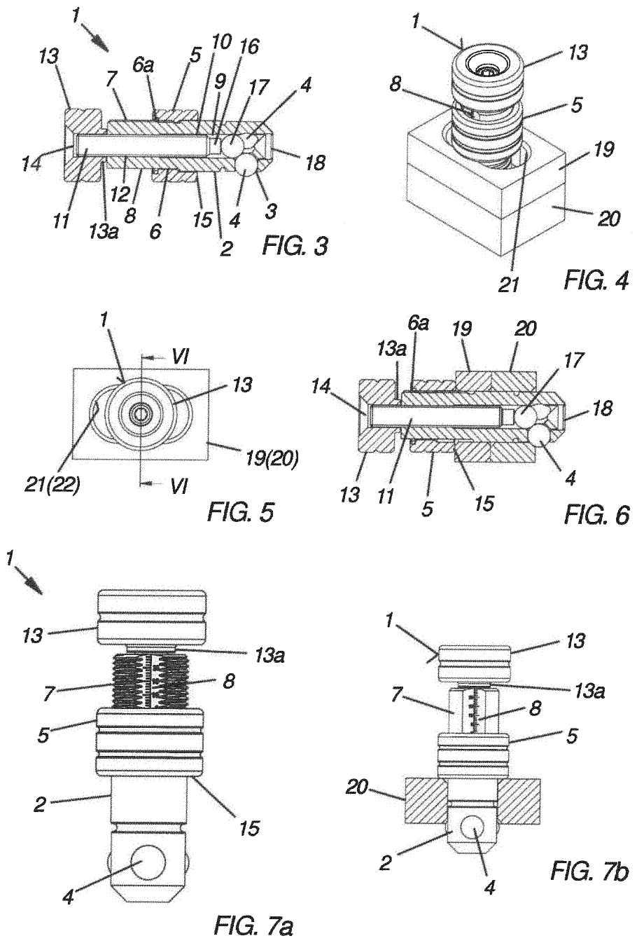

FIG. 3 a section along line III-III of FIG. 2,

FIG. 4 a perspective view of the clamping situation of the bolt in an oblong hole,

FIG. 5 a top view of the clamping situation of the bolt in an oblong hole,

FIG. 6 a section along line VI-VI of FIG. 5,

FIG. 7a an enlarged view of the bolt with a scale,

FIG. 7b a view of the bolt in a cut open part,

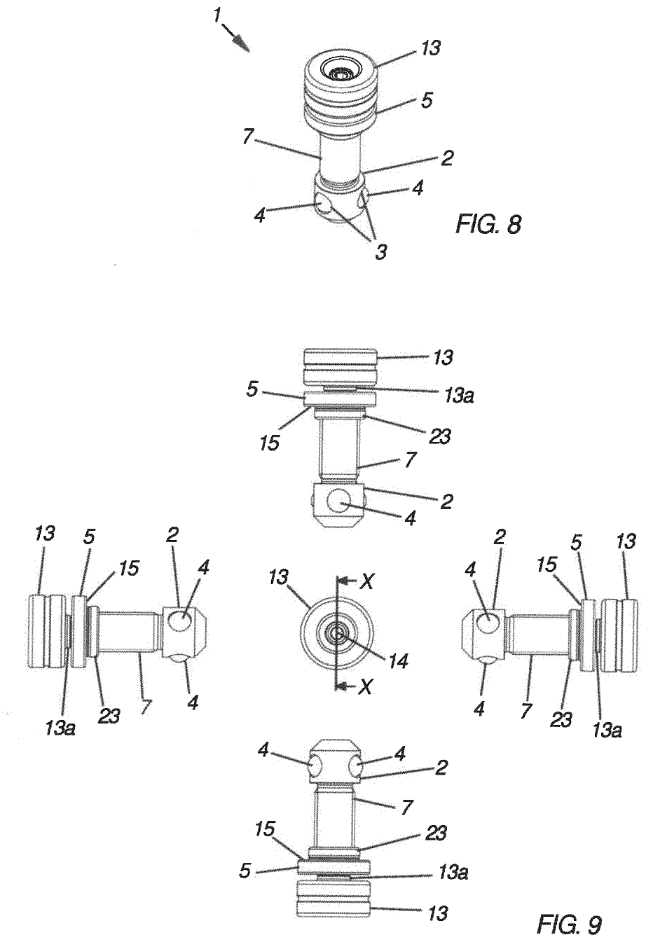

FIG. 8 a perspective view of a second embodiment of the bolt,

FIG. 9 different views of the bolt,

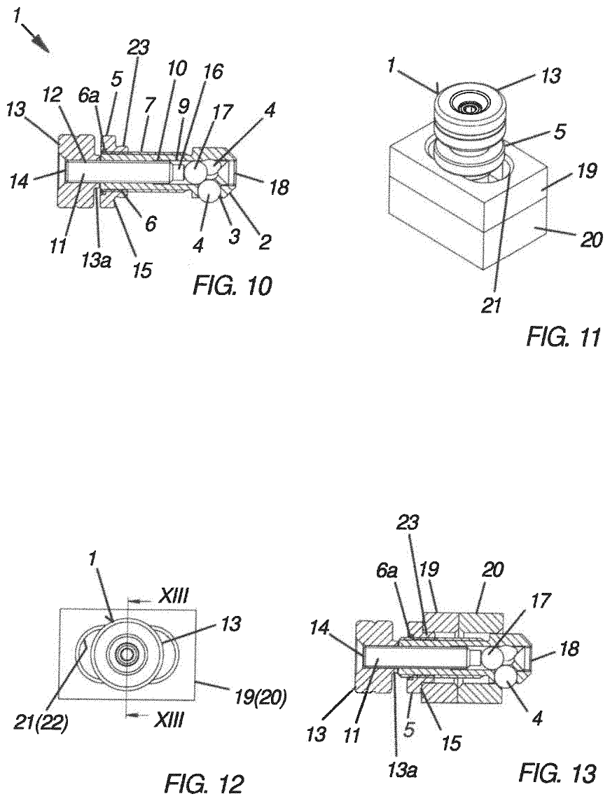

FIG. 10 a section along the line X-X of FIG. 9,

FIG. 11 a perspective view of the clamping situation of the bolt in an oblong hole,

FIG. 12 a top view of the clamping situation of the bolt in an oblong hole,

FIG. 13 a section along line XIII-XIII of FIG. 12.

FIGS. 1, 2 and 3 show a first embodiment of a bolt 1. The bolt 1 includes a bolt-like part 2 which can be inserted into the openings of abutting parts. The bolt-like part 2 is traversed in an end region by openings 3, in which balls 4 can be moved radially back and forth as clamping elements as a result of a not shown beading at the outer edge of the openings 3 or another securement, such as a O-ring, but cannot completely leave the openings 3.

At the other end region of the bolt-like part 2, a threaded sleeve 5 projects radially outwardly from the bolt-like part 2 and is positionally adjustable and fixable in longitudinal direction of the bolt-like part 2 by engaging an internal thread S of the threaded sleeve 5 in an external thread 7 provided on a portion of the outer side of the bolt-like part 2. The threaded sleeve 5 has an internal O-ring 6a, which inhibits the adjustability of the threaded sleeve 5 on the external thread 7, The internal thread 6 is hereby provided only in a partial region of the threaded sleeve 5 and the remaining inner region of the threaded sleeve 5 spans the external thread 7. For reasons of clarity, the external thread 7 is not shown in detail in FIGS. 1 and 2. The external thread 7 has a milled recess in which a scale 8 is attached for setting the thickness of the abutting parts.

A bore 9 is provided inside the bolt-like part 2 and has an internal thread 10. A threaded spindle 11, which has a corresponding external thread 12, can be screwed into the bore 9 in relation to the bolt-like part 2. The threaded spindle 11 projects hereby at the end face beyond the bolt-like part 2 and the threaded sleeve 5 and is widened there to form a handle 13. The handle 13 is connected to the threaded spindle 11 in fixed rotative engagement, optionally in one piece, and has a hexagon socket 14 at its end face for receiving a corresponding wrench with lever arm. On the side facing the bolt-like part 2, the handle 13 is provided with a projection 13a which prevents the bolt 1 from being overtightened and thus become damaged when the clamping range is incorrectly set. However, the projection 13a is selected to be so small and with a corresponding height that there is no risk of crushing the user.

The handle 13 and/or the threaded sleeve 5 can be knurled or coated with a non-slip coating to increase grip.

The threaded sleeve 5 is positionally adjustable and fixable in longitudinal direction relative to the bolt-like part 2 on the external thread 7. The threaded sleeve 5 preferably has hereby the same outer diameter as the handle 13 and, in particular, a greater outer diameter than the diameter of the openings in the abutting parts so that the threaded sleeve rests with its end face 15 upon the part to be clamped.

During clamping, the end 16 of the threaded spindle 11 opposite the handle 13 engages the balls 4 via a central ball 17 and displaces the balls 4 radially outwards. It is understood that the central ball 17 could also be omitted.

A conical set screw 18 is screwed into the bore 9 and serves to limit the radial inward movement of the balls 4. The set screw 18 can be screwed in after the balls 4, 17 have been inserted. For maintenance and/or repair the set screw 18 can be removed again so that the balls 4 can move completely inwards and be removed from the bolt-like part 2.

The clamping situation of the bolt 1 in an oblong hole is explained with reference to FIGS. 4, 5 and 6.

Initially, the clamping range of the bolt 1 is matched to the thickness of the abutting parts 19, 20 by adjusting the threaded sleeve 5 on the external thread 7, using the scale 8. Subsequently, the bolt-like part 2 is inserted into the oblong holes 21, 22 from one side of the abutting parts 19, 20.

The bolt 1 is tightened by screwing the threaded spindle 11 forward with respect to the bolt-like part 2 with the aid of the handle 13, while the threaded sleeve 5 rests with its end 15 at the end face upon one of the abutting parts 19. When the bolt 1 is tightened, the ball 17 pushes the balls 4 radially outwards, until the balls rest upon the other one of the abutting parts 20 and clamp the parts 19, 20.

As is apparent from FIG. 6, the external thread 7 extends only partially into the part 19, so that the bolt 1 inserted into the openings of the abutting parts 19, 20 extends at least partially in each of the abutting parts 19, 20 with a bolt component without external thread 7. In FIG. 6, the bolt-like part 2 extends completely in the part 20 and partially in the part 19 with a region without external thread 7.

In the enlarged view of the bolt 1 of FIG. 7a, the scale 8 can be seen particularly clearly in a milled recess of the external thread 7.

The scale is positioned hereby in such a way that the corresponding thickness of the second part can be set from a part with defined thickness, for example a welding and clamping table. In the illustration of FIG. 7b, the bolt 1 is situated only in a part 20 with defined thickness, for example a welding and clamping table. For this purpose, the threaded sleeve 5 has been set to the position 0 mm of the scale 8. To clamp a metal sheet with a material thickness of 5 mm on the part 20, the threaded sleeve is set to the position 5 mm of the scale 8.

FIGS. 8, 9 and 10 show a second embodiment of a bolt 1, which differs essentially in the design of the threaded sleeve 5 and the external thread 7. Corresponding components are therefore designated with the same reference signs and reference is made in addition to the description of the embodiment of FIGS. 1, 2 and 3.

The threaded sleeve 5 includes a projection 23, which has an outer circumference corresponding to the outer circumference of the bolt-like part 2 and is insertable into one of the openings of the abutting parts. In this embodiment, the external thread 7 can extend across a greater area of the bolt-like part 2. This results in a large range of adjustment while the bolt 1 is of small structural size. An internal O-ring 6a is again provided to inhibit the adjustment of the threaded sleeve 5 on the external thread 7.

The clamping situation of the bolt 1 in an oblong hole is explained with reference to FIGS. 11, 12 and 13.

Initially, the clamping range of the bolt 1 is matched to the thickness of the abutting parts 19, 20 by adjusting the threaded sleeve 5 on the external thread 7, Subsequently, the bolt-like part 2 is inserted into the oblong holes 21, 22 from one side of the abutting parts 19, 20. The projection 23 is hereby inserted into the oblong hole 21.

The bolt 1 is tightened by using the handle 13 to screw the threaded spindle 11 forward relative to the bolt-like part 2, while the threaded sleeve 5 rests with its end 15 at the end face upon one of the abutting parts 19 and is located with its projection 23 in the oblong hole 21. As the bolt 1 is tightened, the ball 17 presses the balls 4 radially outwards until the balls rest upon the other one of the abutting parts 20 and clamp the parts 19, 20.

As is apparent from FIG. 13, the external thread 7 can extend across a greater area of the bolt-like part 2. The bolt-like part 2 only partially extends in the part 20 with an area without external thread 7, and the projection 23 is located in part 19, In this embodiment, it is also ensured that encountered transverse forces cannot act on the external thread 7.

The bolt 1 of this embodiment could also be provided with a scale 8, by providing the external thread 7 with a milled recess in which the scale 8 for adjusting the thickness of the abutting parts is attached.

### LIST OF REFERENCE SIGNS

1 bolt
2 bolt-like part
3 openings in 2
4 balls
5 threaded sleeve
6 internal thread of 5
6a O-ring in 5
7 external thread of 2
8 scale
9 bore in 2
10 internal thread in 9
11 threaded spindle
12 external thread of 11
13 handle of 11
13a projection on 13
14 hexagon socket of 13
15 end of 5 at end face
16 end of 11
17 ball
18 set screw
19, 20 parts
21, 22 oblong holes of 19, 20
23 projection of 5

What is claimed is:

1.-6. (canceled)

7. A bolt with adjustable clamping range for clamping abutting parts, said bolt comprising:
a bolt-like part insertable into openings of the abutting parts from one side of the abutting parts and including an external thread on a portion of an outer side of the bolt-like part, said bolt-like part including at least partially a bolt component without external thread so that the bolt extends in each of the abutting parts at least partially with the bolt component without external thread;
a threaded sleeve projecting radially outwardly beyond the bolt-like part and positionally adjustable and fixable in a longitudinal direction of the bolt-like part by engaging an internal thread of the threaded sleeve in the external thread of the bolt-like part;
a clamping element provided inside the bolt-like part at an end of the bolt-like part in opposition to the threaded sleeve, said clamping element being movable beyond an outer circumference of the bolt-like part through a bore of the bolt-like part; and
an actuator configured to act on the clamping element in order to clamp the abutting parts.

8. The bolt of claim 7, wherein the external thread extends only partially into one of the abutting parts, as the bolt is inserted into the openings of the abutting parts.

9. The bolt of claim 7, wherein the internal thread of the threaded sleeve is provided only in a portion of the threaded sleeve and a remaining internal region of the threaded sleeve spans the external thread of the bolt-like part.

10. The bolt of claim 7, wherein the threaded sleeve includes a projection which has an outer circumference corresponding to the outer circumference of the bolt-like part and is insertable into one of the openings of the abutting parts.

11. The bolt of claim 7, wherein the threaded sleeve includes an internal O-ring which inhibits adjustability of the threaded sleeve on the external thread of the bolt-like part.

12. The bolt of claim 7, wherein the external thread of the bolt-like part has a milled recess, and further comprising a scale received in the milled recess for adjusting a thickness of the abutting parts.
